(19) United States
(12) Patent Application Publication
(10) Pub. No.: US 2018/0209026 A1
(43) Pub. Date: Jul. 26, 2018

(54) Turbine Rotor Blade Manufacturing Method

(71) Applicant: Mitsubishi Hitachi Power Systems, Ltd., Yokohama (JP)

(72) Inventors: Atsuo OTA, Yokohama (JP); Shinya IMANO, Yokohama (JP)

(21) Appl. No.: 15/743,767

(22) PCT Filed: Sep. 14, 2015
(86) PCT No.: PCT/JP2015/076024

§ 371 Date: Jan. 11, 2018

(51) Int. Cl. C22F 1/10; F01D 5/28; C22C 19/05

(52) U.S. Cl. CPC C22F 1/10; F01D 5/28; C22C 19/056; F05D 2230/41; F05D 2300/701; F05D 2260/20; F05D 2230/239; F05D 2300/176; F05D 2230/12; F05D 2240/24

(57) ABSTRACT

In a manufacturing method of a turbine rotor blade using an Ni-based forged alloy, provided is a manufacturing method of a turbine rotor blade having an excellent workability and a high degree of freedom in the design of a cooling structure. A manufacturing method of a turbine rotor blade according to the present invention is, in a manufacturing method of a turbine rotor blade, using an Ni-based forged alloy, characterized by including: a softening process of increasing a γ′ phase incoherent with a γ phase that is a matrix phase in the Ni-based forged alloy; a first working process of forming at least two members constituting a rotor blade by using the Ni-based forged alloy after subjected to the softening process; a second working process of forming cooling structural parts in the respective members; and a third working process of joining the members.

### TECHNICAL FIELD

The present invention relates to a manufacturing method of a turbine rotor blade.

### BACKGROUND ART

Efficiency a thermal power plant is required to increase toward the realization of a low carbon society. A gas turbine is effective for renewable energy that is an unstable supply power source because it has a high load following capability. Further, combined cycle enabling a high efficiency by using a high exhaust temperature and being combined with a steam turbine is put into practical use and a growing demand anticipated.

A rotor blade that one of the constituent components of gas turbine can increase efficiency by increasing an annulus area, for example, by expanding a blade length. A centrifugal stress increases with the increase of a blade length however and hence, in the case of a conventional Ni-based precision cast blade, the tensile strength is insufficient particularly at the root part of a later stage rotor blade. In recent years, a high-strength Ni-based forged material having a creep service temperature equivalent to an Ni-based precision cast material and a tensile strength of not less than 1.5 times is developed and is increasingly put into practical use for aircraft engine disks in Europe. A high-strength Ni-based forged material has been limited to the manufacturing of a small product because of a high high-temperature strength and a low workability but the workability has been improved dramatically by using the technology described in Patent Literature 1 stated below. As a result, a high-strength Ni based forged alloy can be applied to a gas turbine rotor blade and the expansion of a blade length is expected.

Rise of a combustion temperature is effective for the increase of efficiency. The service temperature of a rotor blade also rises accordingly and hence a cooling function is required to be added. In general, a cooling method of cooling a blade from the interior by forming a hollow structure in the blade and feeding a cooling medium is adopted. A serpentine cooling flow passage having a 180-degree bent part is adopted or a rib structure is added in order to increase a cooling efficiency. In a precision cast blade, an intricate cooling flow passage formed by casting molten metal in the state of installing a core having the shape of a cooling flow passage in a mold and removing the core after the metal is solidified. In the case of a forged blade, however, a cooling flow passage has to be formed after the blade is formed and hence only a structure of piercing a hole in one direction from the root part toward the apex part of the blade can be formed by simple machining or electrical discharge machining. Consequently, the degree of freedom in design is low and a high cooling efficiency cannot be realized.

In Patent Literature 1, with regard to a high-strength Ni-based forged alloy in which a γ′ phase that is a precipitation strengthening phase precipitates by 36% to 60% by volume, workability improves by increasing the proportion of a γ′ incoherent phase that does not contribute to strengthening during working.

In Patent Literature 2, disclosed is a manufacturing method of an Ni-based super heat-resistant alloy including the processes of: preparing a hot working material having a composition comprising, by mass, 0.001% to 0.05% C, 1.0% to 4.0% Al, 4.5% to 7.0% Ti, 12% to 18% Cr, 14% to 27% Co, 1.5% to 4.5% Mo, 0.5% to 2.5% W, 0.001% to 0.05% B, 0.001% to 0.1% Zr, with the balance consisting of Ni and impurities; heating the hot working material by retaining it at least for 2 hours in the temperature range of 1,130° C. to 1,200° C.; cooling the hot working material heated at the heating process to a temperature of not higher than a hot working temperature at a cooling rate of not higher than 0.03° C./sec; and applying hot working to the hot orking material after the cooling process. Hot workability is considered to be improved by the method.

### CITATION LIST

### Patent Literature

PTL 1: International Publacation WO 2015/008343

PTL 2: Japanese Patent No. 5692730

### SUMMARY OF INVENTION

### Technical Problem

Patent Literature 1 describes a turbine rotor blade as an example but does not provide a concrete manufacturing method of a rotor blade. Further, Patent Literature 2: is a literature on a method of improving the workability of a high-strength Ni-based forged alloy; is specialized in manufacturing a billet of an alloy having a certain limited composition by improving the hot forgeability; and does not provide a manufacturing method of a turbine rotor blade similarly to Patent Literature 1.

In view of the above circumstances, the present invention, in a manufacturing method of a turbine rotor blade an Ni-based forged alloy, provides a manufacturing method of a turbine rotor blade having an excellent workability and a high degree of freedom in the design of a cooling structure.

### Solution to Problem

In order to solve the problem, the present invention, in a manufacturing method of a turbine rotor blade using an Ni-based forged alloy, provides a manufacturing method of a turbine rotor blade including: a softening process of increasing a γ′ phase incoherent with a γ phase that is a matrix phase in the Ni-based forged alloy; a first working process of forming at least two members constituting the rotor blade by using the Ni-based forged alloy after the softening process; a second working process of forming cooling structural parts in the respective members; and a third working process of joining the members.

### Advantageous Effects of Invention

The present invention, in a manufacturing method of a turbine rotor blade using an Ni-based forged alloy, makes it possible to provide a manufacturing method of a turbine rotor blade having an excellent workability and a high degree of freedom in the design of a cooling structure.

### BRIEF DESCRIPTION OF DRAWINGS

FIG. 1 is a sectional view schematically showing a process in a manufacturing method of a turbine rotor blade according to the present invention.

FIG. 2 is a flowchart showing a manufacturing method of a turbine rotor blade according to the present invention.

FIG. 3 is a view schematically showing temperature profiles and material structure in a softening process.

FIG. 4 is a flowchart explaining the processes S21 to S23 in FIG. 2.

### DESCRIPTION OF EMBODIMENTS

Embodiments according to the present invention are hereunder explained in detail. The present invention, however, is not limited to the embodiments addressed here and can be combined or modified appropriately in the range not changing the tenor.

### [Basic Concept of the Present Invention]

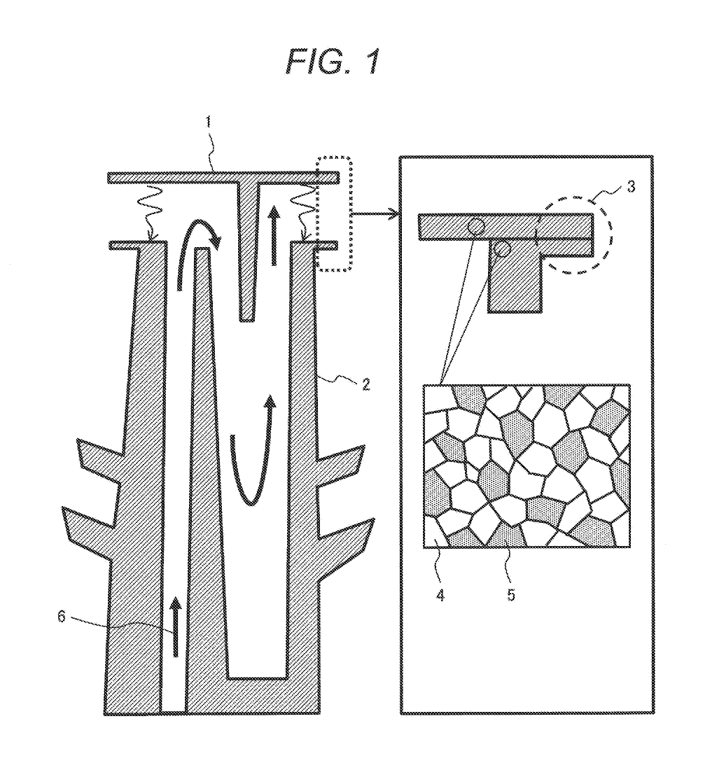

FIG. 1 is a sectional view schematically showing a process in a manufacturing method of a turbine rotor blade according to the present invention. The present inventors have earnestly studied a manufacturing method of a turbine rotor blade (hereunder referred to also as an “Ni-based forged blade”) capable of attaining the above object. As a result, the present inventors have found that an intricate cooling structure can be formed in a blade interior through the following manufacturing process. That is, the workability of an Ni-based forged material is improved by increasing the quantity of a γ′ phase 5 incoherent with a γ phase 4 and then at least two members (members 1 and 2 in FIG. 1) constituting a turbine rotor blade are formed. Then, after cooling structural parts acting as cooling flow passages (cooling structures) of a cooling fluid 6 are formed in the respective members, the respective members are joined. According to the manufacturing method, an intricate cooling structure can be formed n the interior of a forged blade without generating working cracks even in the case of an Ni-based forged alloy containing a γ′ phase of not less than 10% to not more than 40% by mole at not lower than 1,050° C. and having a high high-temperature strength. The present invention is established through the findings.

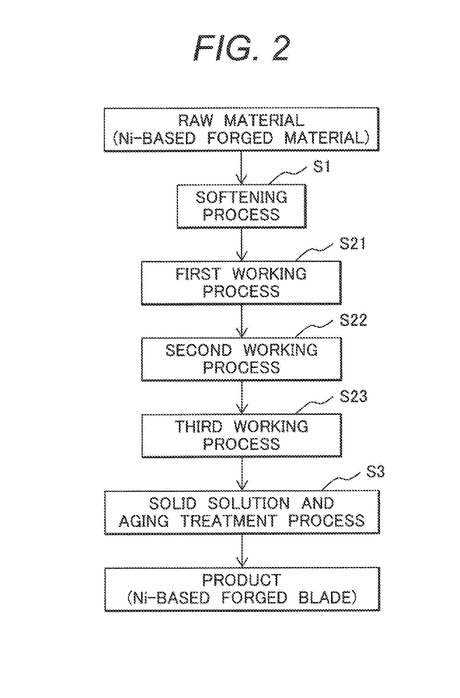

FIG. 2 is a flowchart showing a manufacturing method of a turbine rotor blade according to the present invention. As stated earlier, a manufacturing method of an Ni-based forged blade according to the present invention includes a softening process (S1) of softening an Ni-based forged material (Ni-based forged alloy) that is a raw material, a first working process (S21) of manufacturing at least two members constituting the Ni-based forged blade from the raw material after softened (softened material), a second working process (S22) of forming precursors (cooling structural parts) of a cooling flow passage in the members after the first working process, and a third working process (S23) of joining and integrating a first member and a second member after the second working process and forming a turbine rotor blade (hereunder referred to also as a “rotor blade” or “Ni-based forged blade”) that is a product. The present invention includes the processes S1, S21, S22, and S23 as essential. A solid solution and aging treatment process (S3) for strengthening a rotor blade in a softened state may be applied after the process S23. The respective processes are hereunder explained in detail in reference to drawings.

### (S1: Softening Process)

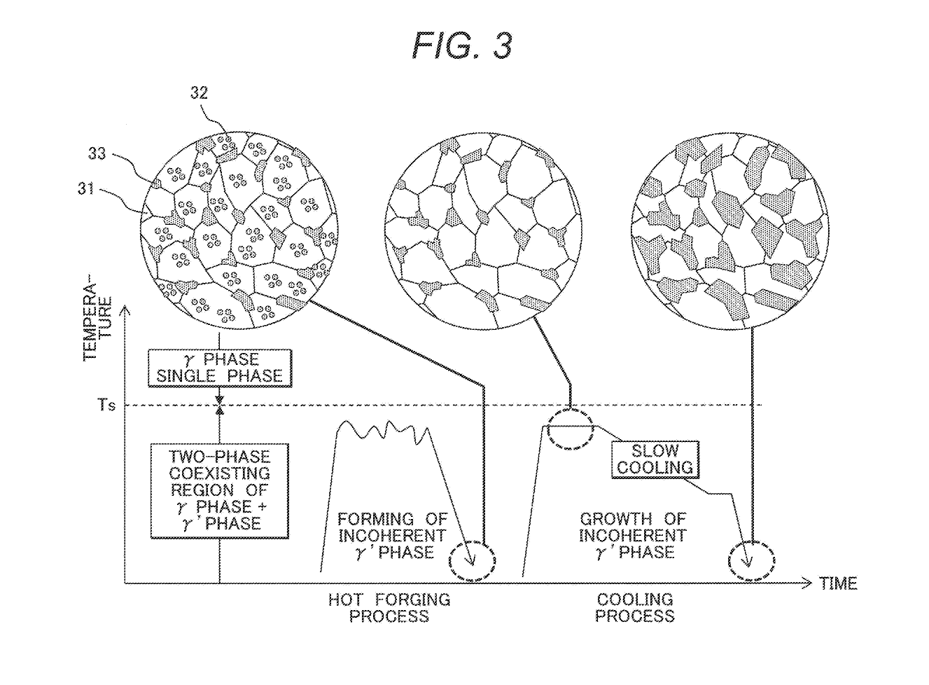

FIG. 3 is a view schematically showing temperature profiles and material structure in the process S1. As shown in FIG. 3, the process S1 includes a hot forging process and a cooling process. First, the hot forging process is explained. In the hot forging process, a γ′ phase incoherent with a γ phase precipitates over the grain boundary of the γ phase by hot-forging an Ni-based forged material at a temperature of not higher than a temperature at which the γ′ phase disappears (solid solution temperature Ts of a γ′ phase) and not lower than a temperature at which the recrystallization of the γ phase advances rapidly. Here, in the present invention, “over the grain boundary of a γ phase” means “a boundary between adjacent γ crystal grains”.

The ground of a hot-forging temperature is shown hereunder. A γ/γ′ phase coherent interface contributes to γ′ phase precipitation strengthening that is the major strengthening mechanism of an Ni-based alloy and strengthening capability disappears by making the γ/γ′ coherent interface incoherent. At the hot-forging process, hot forging is applied at a temperature of not higher than the solid solution temperature of a γ′ phase and not lower than a temperature at which the recrystallization of a γ phase advances rapidly order to precipitate an incoherent γ′ phase. The solid solution temperature of a γ′ phase in a raw material used in the present invention is most desirably not lower than 1,050° C. The effects of the present invention are obtained even when the solid solution temperature of a γ′ phase is 1,000° C. to 1,050° C., but an incoherent γ′ phase hardly precipitates at not higher than 1,000° C. and cannot precipitate at not higher than 950° C., and hence the effects of the present invention cannot be obtained. Further, when the solid solution temperature of a γ′ phase comes close to the melting point of an Ni-based alloy raw material, cracking is generated during working by partial dissolution or the like and hence the solid solution temperature of a γ′ phase is desirably lower than 1,250° C.

A hot-forging temperature has to be not lower than a temperature at which the recrystallization of a γ phase advances rapidly as stated earlier. More specifically, a hot-forging temperature is desirably not lower than 1,000° C. and more desirably not lower than 1,050° C. When a hot-forging temperature is lower than 950° C., an incoherent γ′ phase cannot precipitate and the effects of the present invention are not obtained.

Successively, a cooling (slow cooling) process is explained. At the cooling process, a softened state is realized by: slowly cooling a raw material in which an incoherent γ′ phase 33 precipitates at a cooling rate of not higher than 50° C./h from a temperature of not lower than a hot-forging temperature; increasing (growing) the incoherent γ′ phase 33 not contributing to strength; and thus increasing the quantity of the precipitated γ′ phase 33. In a raw material immediately after hot forging, in addition to an incoherent γ′ phase 33, a coherent γ′ phase 32 also precipitates while the raw material cools from a hot-forging temperature to room temperature. At the cooling process therefore, a dual phase structure comprising a γ phase 31 and an incoherent γ′ phase 33 has to be formed by raising a temperature to a temperature not lower than the hot-forging temperature of a raw material and thus dissolving a coherent γ′ phase 32. A temperature before slow cooling at the cooling process, therefore is desirably a temperature of not lower than the hot-forging temperature of a raw material and not higher than the solid solution temperature of a γ′ phase.

The ground of a cooling rate at a cooling process is shown hereunder. By slowly cooling a raw material from a temperature of not lower than a hot-forging temperature, the precipitation driving force of a coherent γ′ phase 32 lowers and hence an incoherent γ′ phase 33 increases. Consequently, an incoherent γ′ phase 33 can grow more as a cooling rate lowers and a cooling rate is desirably not higher than 50° C./h and more desirably not higher than 10° C./h.

The ground of a cooling end temperature is shown hereunder. By increasing an incoherent γ′ phase 33 by applying slow cooling up to a temperature of not higher than working temperatures at the working processes S21 to S23 described later, a coherent γ′ phase 32 can be inhibited from precipitating at the working temperatures. Further, the precipitation driving force of a coherent γ′ phase 32 lowers as a temperature lowers and precipitation occurs scarcely at not higher than 500° C. A slow cooling end temperature at the cooling process therefore is desirably not higher than the working temperatures of the latter steps and more desirably not higher than 500° C. Through the softening process explained above, a raw material for a rotor blade softens and comes to be in the state of good workability.

### (S21: First Working Process)

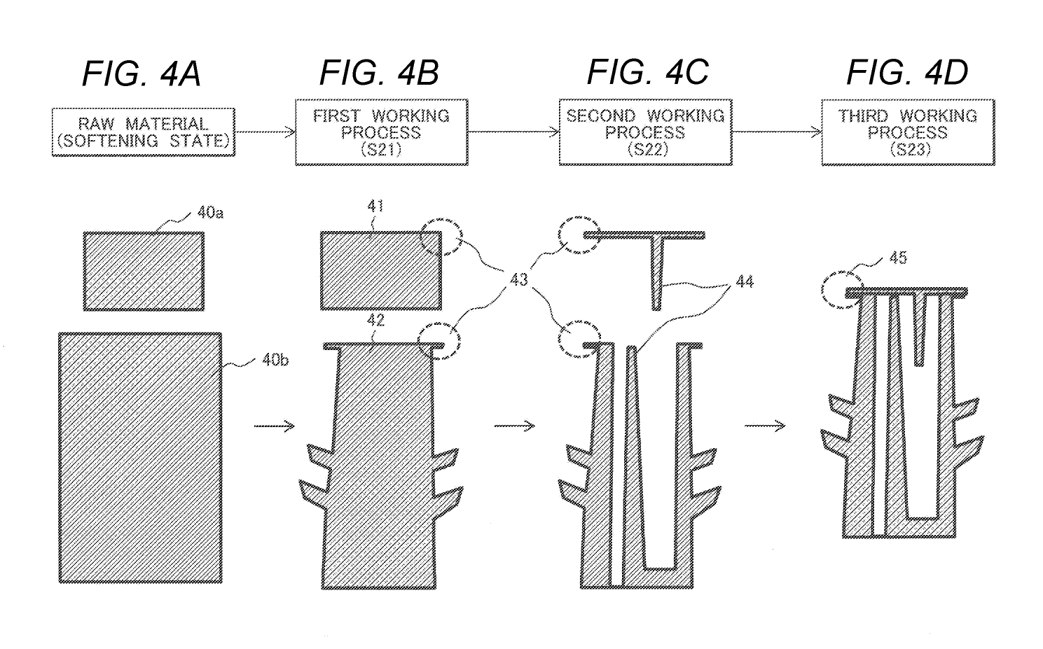

Successively, an Ni-based softened material that has come to a softened state at the above softening process is processed. FIG. 4 is a flowchart explaining the processes S21 to S23 in FIG. 2. First, at the first working process (S21), Ni-based softened materials 40a and 40b ((a) in FIG. 4) are processed to form the shapes ((b) in FIG. 4) of at least two members constituting a rotor blade. In (b) of FIG. 4, a rotor blade is divided into the two members of a member 41 acting as the apex part (top end part) of the rotor blade and a member 42 constituting a blade part (part other than the apex part) of the rotor blade and the two members are processed into respective shapes. On this occasion, as shown by (d) in FIG. 4, joining parts 43 to be the joints of the respective members are formed in the members 41 and 42 at the third working process (S3) described later. The working at the first working process is not particularly limited and can be machining, hot forging (die forging), or both of them.

The joining parts 43 are formed preferably at places where a rotor blade is scarcely affected during joining. When friction stir welding described later is used for the joining of the members in particular, a large load is applied during the joining and hence the joining parts 43 are formed preferably so that a large pressure may not be applied to the parts other than the joining places of the rotor blade. As shown by (b) and (c) in FIG. 4, desirably, protrusions are formed at the ends of the members and the protrusions are used as a joint 45.

### (S22: Second Working Process)

After the first working process, a second working process (S22) of forming cooling structural parts 44 that come to be the precursors of a cooling flow passage in the respective members is carried out. The working at the second working process is not particularly limited and predetermined shapes can be formed by using drilling, electrical discharge machining, or both of them. A burr formed on this occasion is removed because it can be a progress point of a crack in a rotator including a rotor blade.

By forming a structure shown by (c) in FIG. 4 as cooling structural parts 44, for example, after a third working process (S23) described later, a serpentine flow passage in which a cooling flow passage bends at an angle of 180 degrees can be formed. Further, film cooling also possible by forming a hole at a side face of a blade by drilling.

### (S23: Third Working Process)

A third working process of joining the respective members is carried out after the second working process. As the joining, various joining methods can be applied but friction stir welding is applied desirably. As shown by (d) in FIG. 4, the joining parts 43 formed at (c) in FIG. 4 are joined and form a joint 45. As a result, a desired cooling structure (cooling flow passage) is formed by combining the cooling structural parts of the members.

The ground that friction stir welding is preferred is shown hereunder. In general, an Ni-based alloy containing many alloying elements is hardly weldable but, by friction stir welding, can be joined while a joint does not dissolve and a uniform forged structure is retained. As a result, the alloy can be welded without lowering the strength of a joint.

### (S3: Solid Solution and Aging Treatment Process)

A high-temperature strength can be recovered by applying solid solution and aging treatment of dissolving an incoherent γ′ phase and reprecipitating a coherent γ′ phase after the third work in process. In the present invention, the conditions of solid solution treatment and aging treatment are not particularly limited and generally used conditions can be applied. A coherent γ′ phase is contained desirably by not less than 30% by mole at 700° C. after a solid solution and aging treatment process. As long as the content of a coherent γ′ phase is not less than 30% by mole, an Ni-based forged blade having an adequate high-temperature strength can be obtained.

As stated earlier, a cooling structure has heretofore been formed with one member by machining or electrical discharge machining but only a cooling structure of piercing through in one direction from the root part toward the apex part of a blade has been able to be manufactured by this method. According to the present invention, since a rotor blade is manufactured by softening an Ni-based alloy firstly, preparing a plurality of members constituting the rotor blade, forming cooling structural parts in the members, and then assembling the members, a cooling structure of an intricate shape (meandering flow passage) that has heretofore been impossible when a rotor blade is manufactured from one member can be formed. Further, since a uniform forged structure can be retained even after joining by using friction stir welding when members are joined, a rotor blade can be manufactured without lowering the strength of an Ni-based forged material.

Although a manufacturing method of a rotor blade for a gas turbine has heretofore been explained as an embodiment according to the present invention, the method not limited to a gas turbine and can appropriately apply also to another product in the range not changing the tenor. As an example, the method can be applied also to a rotator including a rotor blade of a compressor or a steam turbine.

### EXAMPLES

Examples according to the present invention are explained hereunder.

(1) Manufacturing of Turbine Rotor Blades of Examples 1 to 3 and Comparative Materials 1 to 4

Test materials (Examples 1 to 3 and Comparative materials 1 to 4) are manufactured by using raw materials having the compositions show in Table 1 and carrying out a softening process (S1) to a solid solution and aging treatment process (S3), those being stated earlier. The test materials are evaluated by the methods shown in Table 2. Evaluation results are represented by the symbols “602 ”, “Δ”, and “×” and the evaluation criteria are described in Table 3. In the manufacturing of the test materials, the raw materials are obtained by dissolving 50 kg each of the alloys having the compositions shown in Table 1 by using vacuum induction melting, applying homogenization treatment, and successively hot-forging the alloys at 1,050° C. to 1,250° C. The evaluation results of the test materials are shown in Table 4.

TABLE 1

| | Ni | Cr | Co | Mo | W | Ti | Al | C | B | Zr | Nb | Fe | Hf | Re | Ta |
|---|---|---|---|---|---|---|---|---|---|---|---|---|---|---|---|
| Example 1 | Bal. | 15.6 | 8.4 | 3.0 | 2.6 | 3.5 | 2.3 | 0.01 | 0.01 | 0.03 | 1.1 | 3.9 | — | — | — |
| Example 2 | Bal. | 13.4 | 25.2 | 2.8 | 1.3 | 5.9 | 2.5 | 0.02 | 0.01 | 0.04 | — | — | — | — | — |
| Example 3 | Bal. | 16.0 | 15.1 | 3.0 | 1.3 | 5.3 | 2.5 | 0.01 | 0.02 | 0.03 | 0.00 | 0.15 | — | — | — |
| Comparative | Bal. | 19.8 | 19.0 | 5.9 | — | 2.2 | 0.5 | 0.05 | — | — | — | 0.7 | — | — | — |
| material 1 | | | | | | | | | | | | | | | |
| Comparative | Bal. | 19.0 | 12.1 | 6.2 | 1.0 | 2.9 | 2.0 | 0.03 | — | — | — | — | — | — | — |
| material 2 | | | | | | | | | | | | | | | |
| Comparative | Bal. | 13.1 | 24.8 | 2.9 | 1.2 | 6.0 | 2.4 | 0.02 | 0.02 | 0.05 | — | — | — | — | — |
| material 3 | | | | | | | | | | | | | | | |
| Comparative | Bal. | 7.0 | 1.1 | 0.8 | 8.9 | — | 4.7 | 0.05 | 0.01 | — | 0.75 | — | 0.25 | 1.5 | 8.8 |
| material 4 | | | | | | | | | | | | | | | |

TABLE 2

| | Evaluation 1: γ′ | Evaluation 2: | Evaluation 3: | Evaluation 4: | Evaluation 5: | Evaluation 6: γ′ phase |
|---|---|---|---|---|---|---|
| | phase quantity in | Hardness after | Workability during | Workability during | Workability during | quantity after solid |
| | raw material at | softening process | first working | second working | third working | solution and aging |
| | 1,050° C. | (S1) | process (S21) | process (S22) | process (S23) | treatment process (S3) |
| Evaluation | Calculation based | A raw material is | (1) Die forging is | (1) Cooling | (1) A blade part and | A γ′ phase quantity is |
| method | on thermodynamic | heated to a forging | carried out at | structural parts are | an apex part are | calculated by observing |
| | calculation | temperature | 950° C. and | formed at a blade | joined by friction stir | a texture retained at |
| | | (1,050° C. to | successively pads | part and an apex | welding. | 700° C. for 16 hours after |
| | | 1,250° C.), | are removed by | part by drilling. | (2) When friction stir | retained at 1,050° C. to |
| | | successively | machining. | (2) When drilling is | welding is | 1,150° C. for 4 hours. |
| | | retained for one | (2) When die | impossible, cooling | impossible, the | |
| | | hour, successively | forging cannot be | structural parts are | evaluation finishes. | |
| | | cooled slowly to | cerried out, Pads | formed at a blade | | |
| | | 500° C. at 10° C./h, | are removed by | part and an apex | | |
| | | successively water- | machining. | part by electrical | | |
| | | cooled, and | (3) When both die | discharge | | |
| | | extracted. | forging and | machining. | | |
| | | | machining are | | | |
| | | | impossible, the | | | |
| | | | evaluation finishes. | | | |

TABLE 3

| | Evaluation 1: γ′ | | | | | Evaluation 6: γ′ |
|---|---|---|---|---|---|---|
| | phase | Evaluation 2: | Evaluation 3: | Evaluation 4: | Evaluation 5: | phase quantity after |
| | quantity in | Hardness after | Workability during | Workability during | Workability during | solid solution and |
| | raw material at | softening process | first working | second Waking | third working | aging treatment |
| Evaluation | 1,050° C. | (S1) | process (S21) | process (S22) | process (S23) | process (S3) |
| ∘ | 10 [mol %] or | Hardness not | Die forging and | Electrical discharge | Friction stir | A γ′ phase at 700° C. |
| | more | higher than 350 Hv | machining: possible | machining and | welding: possible | is not less than 30% |
| | | | | drilling: possible. | | by mole |
| Δ | 0 to 10 | Hardness 350 to | Die forging: | Electrical discharge | — | — |
| | [mol %] | not higher than 400 | impossible, | machining: | | |
| | | Hv | machining: possible | possible, drilling: | | |
| | | | | impossible | | |
| x | 0 [mol %] | Hardness net lower | Working: difficult | Working: difficult | Friction stir | A γ′ phase at 700° C. |
| | | than 400 Hv | | | welding: impossible | is not more than |
| | | | | | | 30% by mole |

TABLE 4

| | | | | | | Evaluation 6: γ′ |
|---|---|---|---|---|---|---|
| | Evaluation 1: γ′ | Evaluation 2: | Evaluation 3: | Evaluation 4: | Evaluation 5: | phase quantity after |
| | phase quantity in | Hardness after | Workability during | Workability during | Workability during | solid solution and |
| | raw material at | softening process | first working | second Waking | third working | aging treatment |
| | 1,050° C. | (S1) | process (S21) | process (S22) | process (S23) | process (S3) |
| Example 1 | ∘ | ∘ | ∘ | ∘ | ∘ | ∘ |
| Example 2 | ∘ | ∘ | ∘ | ∘ | ∘ | ∘ |
| Example 3 | ∘ | ∘ | ∘ | ∘ | ∘ | ∘ |
| Comparative | x | ∘ | ∘ | ∘ | ∘ | x |
| material 1 | | | | | | |
| Comparative | Δ | Δ | Δ | Δ | x | |
| material 2 | | | | | | |
| Comparative | ∘ | Not carried out | x | | | |
| material 3 | | | | | | |
| Comparative | ∘ | | | | | |
| material 4 | | | | | | |

(2) Evaluation 1: Evaluation of γ′ Phase Quantity in Raw Material at 1,050° C.

A γ′ phase quantity in a raw material at 1,050° C. is calculated on the basis of thermodynamic calculation. In each of Examples 1 to 3 and Comparative materials 3 and 4, a γ′ phase of not less than 10% by mole exists thermodynamically stably at 1,050° C. In Comparative material 1, no γ′ phase exists because the solid solution temperature of a γ′ phase is not higher than 1,050° C. In Comparative material 2, a γ′ phase exists at 1,050° C. but is not more than 10% by mole. In Comparative material 4, however, a γ′ phase quantity exceeds 40% by mole at 1, 050° C., a large crack is caused during the process of making a forged material by forging a raw material in the evaluation after the process S1 described later, and hence the evaluation is finished. In this way, since a raw material can hardly be forged when a γ′ phase quantity at not lower than 1,050° C. exceeds 40% by mole, a γ′ phase quantity is desirably not more than 40% by mole.

(3) Evaluation 2: Evaluation of Hardness After Softening Process (S1)

Each of the test materials is heated to a forging temperature (1,050° C. to 1,250° C.), then water-cooled after slowly cooled to 500° C. at 10° C./h, and extracted. Successively, a test piece 0.5 to 1.0 mm in size is taken out from an end of the test material and a hardness is measured with a micro Vickers hardness tester.

Examples 1 to 3 and Comparative material 1 are not higher than 350 Hv respectively. Comparative material 2 shows a hardness of 350 to 400 Hv. With respect to Comparative material 3, the softening process (S1) is not carried out and the first working process (S21) of the latter step is carried out. As a result of observing a structure on this occasion with a scanning electron microscope, it is confirmed that, in each of Examples 1 to 3, a dual phase structure comprising a γ phase and an incoherent γ′ phase is formed. In each of Comparative materials 1 and 2, an incoherent γ′ phase is not recognized and a coherent γ′ phase precipitates. In Comparative material 1, since a forging temperature is set at a temperature not lower than the solid solution temperature of a γ′ phase, an incoherent γ′ phase does not precipitate and the effects of the present invention are not obtained. In Comparative material 2, although a forging temperature is not lower than the solid solution temperature of a γ′ phase, the γ′ phase quantity at 1,050° C. evaluated in Evaluation 1 is small and the effects of the present invention are presumably not obtained sufficiently. In Comparative material 3, both an incoherent γ′ phase and a coherent γ′ phase precipitate. This is because an incoherent γ′ phase precipitates while a raw material is forged before the softening process (S1) and successively a coherent γ′ phase precipitates during the process of cooling the raw material to room temperature.

(4) Evaluation 3: Evaluation of Workability During First Working Process (S21)

At the first working process, firstly members acting as an apex part and a blade part of a rotor blade are manufactured by applying die forging at 950° C. A case where a load of press is insufficient during forging and a test material does not deform or a case where a defect such as a crack is generated in the interior or on the surface test material after forging is judged as not workable. With regard to machining, a case where a tool wears significantly or a defect is generated during working is judged as not workable.

Each of Examples 1 to 3 and Comparative material 1 can be worked by both die forging and machining. Comparative material 1 is workable because the quantity of a γ′ phase is small and strength is low although an incoherent γ′ phase does not precipitate at the softening process S1 and the softening process in the present invention does not contribute. In Comparative material 2, machining is possible but die forging is impossible. Further, in Comparative material 3, both die forging and machining are impossible. This is because Comparative material 3: is a high-strength material in which the solid solution temperature of a γ′ phase is not lower than 1,050° C.; precipitates a coherent γ′ phase during working because a softening process is not applied; and is in the state of low workability. For the reason, the softening process S1 has to be applied in order to obtain good workability when a thermodynamically stable Ni-based alloy containing a γ′ phase of not leas than 10% by mole at not lower than 1,050° C. is subjected to die forging and machining.

(5) Evaluation 4: Evaluation of Workability During Second Working Process (S22)

At the second working process, firstly a cooling structural part is formed in a test material at room temperature by drilling. On occasion, a case where a tool wears significantly or a defect is generated during working is judged as not workable, in the same manner as Evaluation 3. Electrical discharge machining can be applied because all the test materials are made of metal.

Each of Examples 1 to 3 and Comparative material 1 can be worked by both the methods of drilling and electrical discharge machining. In Comparative material 1, workability is good but the strength of the raw material itself is low as stated earlier and hence the softening process in the present invention does not contribute. In Comparative material 2, drilling is impossible but electrical discharge machining is possible.

(6) Evaluation 5: Evaluation of Workability During Third Working Process (S23)

At the third working process, an apex part and a blade part are joined by friction stir welding. A case where a tool cannot be pushed into a test material, a case where a tool wears or breaks significantly during working, or a case where a defect, a specific harmful phase, or the like is recognized in an interior at a joint is judged as joining is impossible.

In each of Examples 1 to 3 and Comparative material 1, joining is possible and, by observation with a microscope, a defect and the like are not recognized at a joint and a fine polycrystalline structure is observed. That is, a uniform forged structure is observed in a whole rotor blade including a joint. In Comparative material 2, a tool cannot be pushed in and joining is impossible.

(7) Evaluation of γ′ Phase Quantity After Solid Solution and Aging Treatment Process (S23)

Solid solution and aging treatment is carried out under a standard heat treatment condition of each test material and the quantity of a precipitated coherent γ′ phase is calculated by succeeding structure observation and image analysis. In each of Examples 1 to 3, a coherent γ′ phase of not less than 30% by mole precipitates at 700° C. and a rotor blade having an adequate high-temperature strength can be obtained. In Comparative material 1, a γ′ phase quantity is not more than 30% by mole at 700° C.

From the above results, it is verified that the present invention makes it possible, in a manufacturing method of a turbine rotor blade using an Ni-based forged alloy, to provide a manufacturing method of a turbine rotor blade having an excellent workability and a high degree of freedom in the design of a cooling structure.

Meanwhile, the above examples are explained concretely in order to help the present invention to be understood and the present invention does not necessarily have all the explained configurations. For example, a part of the configuration of a certain example can be replaced with the configuration of another example and the configuration of a certain example can be a dried to the configuration of another example. Further, a part of the configuration of each example can be deleted, replaced with another configuration, or added to another configuration.

### REFERENCE SIGNS LIST

1, 41 First member
2, 42 Second member
3, 45 Joint
4, 31 γ phase
5, 33 Incoherent γ′ phase
32 Coherent γ′ phase
43 Joining part
44 Cooling structural part
S1 Softening process
S21 First working process
S22 Second working process
S23 Third working process
S3 Solid solution and aging treatment process

1.-20. (canceled)

21. A manufacturing method of a turbine rotor blade, in a manufacturing method of a turbine rotor blade using an Ni-based forged alloy, comprising:
a softening process of increasing a γ′ phase incoherent with a γ phase that is a matrix phase in the Ni-based forged alloy;
a first working process of forming at least two members constituting a rotor blade by using the Ni-based forged alloy after subjected to the softening process;
a second working process of forming cooling structural parts in the respective members; and
a third working process of joining the members.

22. A manufacturing method of a turbine rotor blade according to claim 21, wherein the members are joined by friction stir welding at the third working process.

23. A manufacturing method of a turbine rotor blade according to claim 21, wherein the softening process comprises:
a hot forging process of being applied at a temperature of not higher than the solid solution temperature of a γ phase and not lower than a temperature at which the recrystallization of the γ phase advances rapidly and precipitating an incoherent γ′ phase; and
a cooling process of applying slow cooling from a temperature of not lower than a hot-forging temperature and increasing the incoherent γ′ phase.

24. A manufacturing method of a turbine rotor blade according to claim 23, wherein: the hot-forging temperature is not lower than 1,050° C. to lower than 1,250° C.; and a cooling rate at the cooling process is not lower than 10° C./h to not higher than 50° C./h.

25. A manufacturing method of a turbine rotor blade according to claim 21, wherein at least one of the members is formed by machining at the first working process,

26. A manufacturing method of a turbine rotor blade according to claim 21, wherein at least one of the members is formed by hot forging at the first working process.

27. A manufacturing method of a turbine rotor blade according to claim 21, wherein the cooling structural part is formed in at least one of the members by drilling at the second working process.

28. A manufacturing method of a turbine rotor blade according to claim 21, wherein the cooling structural part is formed in at least one of the members by electrical discharge machining at the second working process.

29. A manufacturing method of a turbine rotor blade according to claim 21, further comprising a solid solution and aging treatment process after the third working process.

30. A manufacturing method of a turbine rotor blade according to claim 21, wherein the Ni-based forged alloy comprises a γ′ phase of not less than 10% to not more than 40% by mole at not lower than 1,050° C.

31. A manufacturing method of a turbine rotor blade according to claim 29, wherein the Ni-based forged alloy after the solid solution and aging treatment process contains a γ′ phase coherent with a matrix phase by not less than 30% by mole at not higher than 700° C.

32. A manufacturing method of a turbine rotor blade according to any one of claims 21 to 29, wherein a joint of the members joined at the third working process has a forged structure.

33. A manufacturing method of a turbine rotor blade according to any one of claims 21 to 29, wherein the members are members constituting the blade part and the apex part of the turbine rotor blade.

34. A manufacturing method of a turbine rotor blade according to any one of claims 21 to 29, wherein the cooling structural parts constitute a cooling structure of the turbine rotor blade by joining the members at the third working process.

35. New A manufacturing method of a turbine rotor blade according to claim 22, wherein the softening process comprises:
a hot forging process of being applied at a temperature of not higher than the solid solution temperature of a γ phase and not lower than a temperature at which the recrystallization of the γ phase advances rapidly and precipitating an incoherent γ′ phase; and
a cooling process of applying slow cooling from a temperature of not lower than a hot-forging temperature and increasing the incoherent γ′ phase.

36. A manufacturing method of a turbine rotor blade according to claim 22, wherein at least one of the members is formed by cutting at the first working process.

37. A manufacturing method of a turbine rotor blade according to claim 23, wherein at least one of the members is formed by cutting at the first working process.

38. A manufacturing method of a turbine rotor blade according to claim 24, wherein at least one of the members is formed by cutting at the first working process.

39. A manufacturing method of a turbine rotor blade according to claim 22, wherein at least one of the members is formed by hot forging at the first working process.

40. A manufacturing method of a turbine rotor blade according to claim 23, wherein at least one of the members is formed by hot forging at the first working process.
